(19) United States
(12) Patent Application Publication
(10) Pub. No.: US 2018/0157729 A1
(43) Pub. Date: Jun. 7, 2018

(54) DISTRIBUTED IN-MEMORY DATABASE SYSTEM AND METHOD FOR MANAGING DATABASE THEREOF

(71) Applicant: ELECTRONICS AND TELECOMMUNICATIONS RESEARCH INSTITUTE, Daejeon (KR)

(72) Inventor: Mi Young LEE, Daejeon (KR)

(73) Assignee: ELECTRONICS AND TELECOMMUNICATIONS RESEARCH INSTITUTE, Daejeon (KR)

(21) Appl. No.: 15/631,774

(22) Filed: Jun. 23, 2017

(30) Foreign Application Priority Data
Dec. 6, 2016 (KR) 10-2016-0165293

(51) Int. Cl. G06F 17/30; G06F 9/50; H04L 29/08

(52) U.S. Cl. CPC G06F 17/30575; H04L 29/08018; H04L 67/1029; G06F 9/505

(57) ABSTRACT

Disclosed herein is a distributed in-memory database system for partitioning a database and allocating the partitioned database to a plurality of distributed nodes, wherein at least one of the plurality of nodes includes a plurality of central processing unit (CPU) sockets in which a plurality of CPU cores are installed, respectively; a plurality of memories respectively connected to the plurality of CPU sockets; and a plurality of database server instances managing allocated database partitions, wherein each database server instance is installed in units of CPU socket groups including a single CPU socket or at least two CPU sockets.

### CROSS-REFERENCE TO RELATED APPLICATION

This application claims priority to and the benefit of Korean Patent Application No. 10-2016-0165293 filed in the Korean Intellectual Property Office on Dec. 6, 2016, the entire contents of which are incorporated herein by reference.

### BACKGROUND OF THE INVENTION

### (a) Field of the Invention

The present invention relates to a distributed in-memory database system and a method for managing a database thereof. More particularly, the present invention relates to a method for managing a distributed in-memory database having a shared-nothing architecture in distributed nodes environment including multiple processors having a non-uniform memory access (NUMA) architecture.

### (b) Description of the Related Art

A database system is different in an optimal system architecture and a data storage management method depending on whether a workload is based on transactional processing or analytical processing.

A distributed in-memory database system for analytical processing generally adopts a shared-nothing architecture in which a database is partitioned and data partitions are allocated to each node and data is independently managed by each node such that data sharing among the distributed nodes is minimized.

That is, each node exclusively manages a portion of the database allocated thereto, and, for data managed by other nodes, each node sends data processing request and receives and utilizes a processing result. Within a node, a plurality of query processing threads operate to access all in-memory data managed within the node and it is regarded that an access time to all data within the node is physically the same.

However, in cases where a multi-processor system constituting a node has a non-uniform memory access (NUMA) architecture, a data access delay to rate and a data transfer bandwidth are varied depending on a memory position in which data is stored and a core position in which a query processing thread is executed, and thus, a method for managing data within a node is required to be reconsidered.

In the multi-processor system having the NUMA architecture, a plurality of cores, several layers of cashes, a memory controller, and an inter-socket link are packaged within a single central processing unit (CPU) socket, and several CPU sockets are inter-connected by the inter-socket links according to interconnection topology. A socket connection network may have fully connected architecture in which every socket is accessible by one hop or a partially connected architecture in which every socket is accessible through several hops.

The multi-processor system has NUMA characteristics that an access delay rate of a local memory in which a core is directly accessible through a memory controller and an access delay rate of a remote memory in which a core is accessible through an inter-socket link are different. When the number of connected CPU sockets is small, a ratio of a remote memory access to a local memory access may not be high and a difference in rate between the local memory access and the remote memory access may be reduced, but, as the number of CPU sockets is increased, a local memory access performance effect is relatively increased.

Thus, in the distributed in-memory database system including multiple processors having the NUMA architecture, performance variations may be significant depending on a memory position in which accessed data is stored and a core position of query processing thread within a node, and thus, a method for applying a distribution concept within a node is proposed. That is, a shared-nothing database management method of executing a processing thread by core and designating a data partition to be handled by each thread is proposed.

The core-based shared-nothing architecture is advantageous in that a cache can be effectively utilized; however, since only one thread can access specific data, the database system is required to be re-designed on data-centric. That is, the core-based shared-nothing architecture is difficult to extendedly apply to the existing transaction centric-database system in which several threads simultaneously access data.

In the shared-nothing architecture, when a load balance of database server instances may be lost according to a utilization situation of each partition, and thus, when a specific instance is overloaded, overall query processing performance is degraded. In order to solve this problem, a method for dynamically re-configuring partitions by monitoring partitions and a resource utilization is used. As the number of partitions and the number of database server instances are increased, the searching space for an optimal partition reconfiguring method is increased and it makes a time and computing resource consumption for deriving an optimal method increase. Also, as reconfigured database server instances are increased, an entire database service is delayed. To this end, a candidate group set is limited in reconfiguring partitions to shorten a partition plan establishment time, but research into a method for limiting a candidate group set with consideration for even cost incurred for partition reconfiguration has not been conducted yet.

### SUMMARY OF THE INVENTION

The present invention has been made in an effort to provide a distributed in-memory database system and a method for managing a database thereof having advantages of increasing a local memory access proportion as high as possible and reducing a cost of a load balancing to enhance an analytical query processing rate in the distributed in-memory database system including multiple processors having NUMA characteristics.

An exemplary embodiment of the present invention provides a distributed in-memory database system for partitioning a database and allocating the partitioned database to a plurality of distributed nodes. At least one of the plurality of nodes may include: a plurality of central processing unit (CPU) sockets in which a plurality of CPU cores are installed, respectively; a plurality of memories respectively connected to the plurality of CPU sockets and having a non-uniform memory access (NUMA) architecture in which a memory access rate of the plurality of CPU sockets is not uniform depending on a memory connection position; and a plurality of database server instances managing allocated database partitions, wherein each database server instance is installed in units of CPU socket groups including a single CPU socket or at least two CPU sockets.

The plurality of database server instances may dynamically adapt to a change in a workload to perform hardware resource allocation adjustment and partition allocation adjustment.

The plurality of database server instances may establish hardware resource allocation adjustment and partition allocation adjustment by stages, starting from a candidate target group incurring lower cost in consideration of cost for load adjustment and for accessing a database after load adjustment.

The plurality of database server instances may each adjust a load for groups available for low-cost resource reallocation based load adjustment in a first step performing local adjustment within a group by stages, starting from a group with low database access cost, and when the resource reallocation based load adjustment is impossible, the plurality of database server instances may each perform local partition adjustment within a group by stages, starting from a group with low cost for partition transfer for groups available for partition reallocation based load adjustment.

The group available for resource reallocation based load adjustment may include at least one group including database server instances driven within a node available for hardware resource sharing, and the group available for the partition reallocation based load adjustment may include at least one group including database server instances driven in other nodes.

When the overload is not resolved through the hardware resource allocation adjustment and partition allocation adjustment by stages, the plurality of database server instances may re-allocate the entire partitions.

Another exemplary embodiment of the present invention provides a method for managing a database in a distributed in-memory database system for partitioning the database and allocating the partitioned database to a plurality of distributed nodes. The method for managing a database includes: installing and operating database server instances storing and managing a partitioned database on a at least one central processing unit (CPU) socket and a dynamic random-access memory (DRAM) directly connected to each CPU socket; obtaining hardware allocation information and partition and resource utilization information of operated database server instances; determining an overloaded database server instance on the basis of the hardware allocation information and the partition and resource utilization information; and when the overloaded database server instance is present, adjusting a load of the overloaded database server instance in consideration of cost for load adjustment and for accessing a database after load adjustment.

At least one of the plurality of nodes may include: a plurality of central processing unit (CPU) sockets in which a plurality of CPU cores are installed, respectively; a plurality of memories respectively connected to the plurality of CPU sockets and having a non-uniform memory access (NUMA) architecture in which a memory access rate of the plurality of CPU sockets is not uniform depending on a memory connection position; and a plurality of database server instances managing an allocated database partition.

The adjusting of the load may include: grouping database server instances in consideration of cost for adjusting the load and for accessing the database; obtaining priority information of groups; and performing hardware resource allocation adjustment and partition allocation adjustment by stages, starting from a group with higher priority.

The grouping may include grouping database server instances driven within the same node to at least one group available for resource allocation adjustment in consideration of a memory access rate and grouping database server instances driven in other nodes to at least one group available for partition allocation adjustment in consideration of a partition transfer rate.

The performing of hardware resource allocation adjustment and partition allocation adjustment may include: a first step of performing local load adjustment within a group by stages for groups available for resource reallocation based load adjustment with low cost for load adjustment; and a second step of performing local load adjustment within a group by stages for groups available for partition reallocation based load adjustment, when the resource reallocation based load adjustment is impossible.

The first step may include: obtaining the resource reallocation based load adjustment available group list and inter-group priority information; obtaining hardware resource allocation information and partition and resource utilization information of database server instances within a group, for each group in accordance with priority; when available hardware resource is present on the basis of the hardware resource allocation information and resource utilization information, configuring priority of candidate database server instances to share a load in consideration of utilization of resource and cost for accessing a remote memory; selecting at least one candidate database server instance to which hardware resource is to be provided on the basis of priority of the candidate database server instances; establishing a resource allocation policy appropriate for the at least one selected candidate database server instance and an overloaded database server instance; and re-allocating hardware resource to the at least one candidate database server instance and the overloaded database server instance on the basis of the resource allocation policy.

The second step may further include: obtaining the reallocation based load adjustment available group list and inter-group priority information; obtaining hardware resource allocation information and partition and resource utilization information of database server instances within a group, for each group in accordance with priority; configuring priority of candidate database server instances to share a load on the basis of the hardware resource allocation information and the partition and resource utilization information; selecting at least one transfer partition candidate and one candidate database server instance to participate in transfer on the basis of resource utilization information and partition utilization information of each partition of the candidate database server instances and the overloaded database server instance; and re-allocating the transfer partition candidates to the database server instances to participating in the transfer.

The second step may further include: when the previous partition candidate is required to be partitioned, partitioning the corresponding partition.

The adjusting of a load may further include: when the overload is not resolved through the hardware resource allocation adjustment and partition allocation adjustment by stages, re-allocating the entire partitions.

### BRIEF DESCRIPTION OF THE DRAWINGS

FIG. 1 is a view illustrating a distributed in-memory database system having a shared-nothing architecture according to an exemplary embodiment of the present invention.

FIG. 2 is a view illustrating a plurality of CPU cores installed in a CPU socket of FIG. 1.

FIG. 3 is a flow chart illustrating a method for balancing loads by adjusting resource allocation and partition to database server instances in a distributed in-memory database system having a shared-nothing architecture according to an exemplary embodiment of the present invention.

FIG. 4 is a flow chart illustrating a method for adjusting a local load by stages on the basis of resource allocation adjustment illustrated in FIG. 3.

FIG. 5 is a flow chart illustrating a method for adjusting a local load by stages on the basis of partition allocation adjustment illustrated in FIG. 3.

FIG. 6 is a view illustrating a module structure of a distributed in-memory database system having a shared-nothing architecture according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising”, will be understood to imply the inclusion of stated elements but not the exclusion of any other elements.

Hereinafter, a distributed in-memory database system and a method for managing a database thereof according to an exemplary embodiment of the present invention will be described in detail with reference to the accompanying drawings.

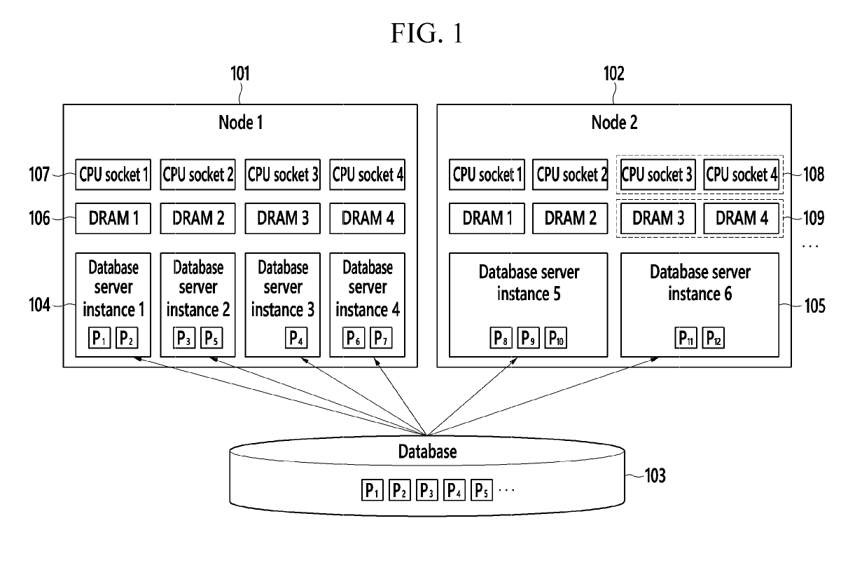

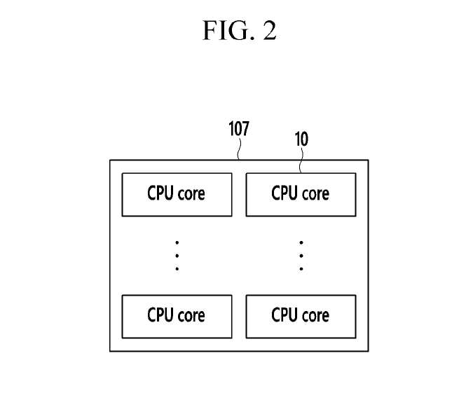

FIG. 1 is a view illustrating a distributed in-memory database system having a shared-nothing architecture according to an exemplary embodiment of the present invention, and FIG. 2 is a view illustrating a plurality of CPU cores installed in a CPU socket of FIG. 1. In FIG. 2, only a single CPU socket is illustrated for the purposes of description.

The distributed in-memory database system having a shared-nothing architecture may be defined as a set of computer nodes (hereinafter, referred to as “nodes”) 101 and 102 distributed in a computer network.

In the distributed in-memory database system having a shared-nothing architecture, generally, a database server instance is driven in each of the nodes 101 and 102, and a database 103 is partitioned to allocate partitions to be managed by each database server instance, whereby the database server instances independently manage allocated database partitions. A database is partitioned on the basis of a reference proposed by a user such as a range basis, a hash basis, and the like, with respect to a table key, and partition allocation is determined in consideration of available hardware resource of a database server instance, an estimated partition size, prediction regarding a data utilization pattern of an application, and the like. The determined partition allocation information are stored and managed in the system, and query processing is performed using the information.

When a database server instance receives a query request from a user, the database server instance serves as a coordinator, and the coordinator requests database server instances managing a required data partition to distribute a query according to a query processing flow, receives a processing result from database server instances, processes the received result integratedly, and provides the result to the user, thus performing the user query processing.

In cases where hardware of the nodes 101 and 102 is a multi-processor having a NUMA architecture, if the number of processors is increased, variations of a memory access delay rate are increased depending on a CPU socket connection network and a position of a dynamic random-access memory (DRAM) to be accessed. In the case of loading and managing every data within a DRAM, like the in-memory database system, memory access delay is required to be minimized.

Thus, as illustrated in FIG. 1, in the distributed in-memory database system having a shared-nothing architecture according to an exemplary embodiment of the present invention, a physical computer system unit in which a database server instance independently managing data is installed is set in each CPU socket unit forming the nodes 101 and 102, as well as the respective nodes 101 and 102. That is, a unit in which an independent database server instance is to be installed may be designated as a partial CPU socket group, a single CPU socket, and the like, a database is stored in a DRAM corresponding to a memory placed in the designated unit, and query processing threads accessing thereto are limited to be executed in the designated unit.

In detail, referring to FIG. 1, database server instances may be respectively installed in units of single CPU sockets within the node 1 101, database server instances may be respectively installed in units of CPU socket groups including two CPU sockets within the node 2 102. As illustrated in FIG. 2, each CPU socket 107 within the node 1 101 and the node 2 102 includes a plurality of CPU cores 10 and is connected to a corresponding DRAM. Also, database server instances executed within the node 1 101 and node 2 102 manage database partitions P₁, P₂, . . . allocated thereto.

Within the node 1 101 and the node 2 102, the database server instances 104 and 105 may use only the CPU sockets 107 and 108 and DRAMs 106 and 109, respectively. For example, the database server instance 1 104 within the node 1 101 may use only the CPU socket 1 107 and a DRAM 1 106 and manage database partitions P₁ and P₂ allocated to the database server instance 1 104. The database server instance 6 105 within the node 2 102 may use only the CPU socket group 108 including a CPU socket 3 and a CPU socket 4 and a memory 109 including a DRAM 3 and a DRAM 4 and manage database partitions P₁₁ and P₁₂ allocated to the database server instance 6 105.

By configuring a hardware environment as illustrated in FIG. 1 when the database server instances 104 and 105 are driven within the node 1 101 and the node 2 102, an environment appropriate for a NUMA architecture affecting memory access delay such as the number of CPU sockets, a inter-CPU socket connection network topology, and the like, may be configured.

The execution environment of the database server instance 104 and 105 may be configured using a function (e.g., sched_setaffinity( ) of Linux) of disposing in a specific CPU when scheduling a process and a thread provided by a system operating system in which an in-memory database system is installed, a function (e.g., numactl( ) option) of allocating a memory page in a DRAM connected to a specific CPU socket or a CPU socket group by a process, and the like.

The distributed in-memory database system having a shared-nothing architecture has a following query processing flow. That is, in order to process a query, the query is partitioned so that a plurality of data server instances perform query processing in parallel, merge the result, and process a next step. In this case, if a processing rate is delayed due to an overload of a specific database server instance, a bottleneck phenomenon occurs to degrade overall query processing performance.

Thus, in order to prevent a degradation of data analytical processing performance due to the overloaded database instance, a load balance should be maintained by dynamically adapting to a change in a workload.

In an exemplary embodiment of the present invention, in order to minimize cost incurred for establishing a reconfiguration plan for a load balance and implementing a load balance according to the established reconfiguration plan, a solution to a problem is limited to be locally reconfigured and a stepwise adjustment plan establishing method of expanding a locally limited range by stages is used.

A method of reconfiguring partitions by obtaining an optimal configuration plan globally through entire database server instances may derive to an optimal plan, but increases in the number of partitions and the number of database server instances increases a time and computing resource consumption to derive an optimal plan. Also, more change-influenced database server instances cause delay in the entire database service.

Meanwhile, a method of obtaining a reconfiguration plan by locally limiting database server instances has a smaller number of cases, reducing a time and computing resource consumption for deriving an optimal plan, and incurring less adjustment cost for implementing a load balance according to an adjustment plan. For example, in a hardware configuration environment including nodes, adjustment of a load balance between database server instances running within a node incurs least cost and high cost incurs for a load balance between database server instances running in different racks.

Local stepwise adjustment method may incur a less time and cost and may not be an optimal plan overall, but it may promptly cope with a degradation in performance due to an overload.

In the existing environment in which installation of database server instances is fixated by nodes, only a method for adjusting the number or a size of partitions handled by each database server instance may be used to cope with a workload, but in an environment in which database server instances are configured by CPU sockets in multiple processors, a workload may be adjusted by adjusting resource allocation incurring less cost, such as a change in a DRAM and a CPU socket group to which a database server instance is bound.

Although memory access delay occurs due to NUMA after resource allocation adjustment, it may be better to select a method of primarily adjusting resource allocation and monitoring a situation, and transferring a partition to another node when a problem arises, than a method of transferring a partition to another node during a service. Thus, a method of adjusting resource allocation or a method of readjusting a partition in consideration of computing environment characteristics is selectively used as a load balance adjustment method.

Thus, in an exemplary embodiment of the present invention, in order to dynamically adapt to a workload, resource allocation adjustment and partition allocation adjustment are integratedly utilized, and in order to solve a problem through a change as small as possible at low cost, a stepwise load adjustment method of preferentially searching for a local optimal solution is used.

Grouping for searching for a local optimal solution by stages, selecting priority of groups, and a method of adjusting load distribution within a group, and the like, may be performed in consideration of cost incurred for adjusting a load and for accessing a database after load adjustment, and the like. For example, grouping may include a group including database server instances driven within a node, a group including database server instances driven in different nodes belonging to the same rack, a group including database server instances driven in nodes belonging to different racks, and the like. Also, unless all CPU sockets within a node are completely connected, database server instances within the node may be configured to several groups in consideration of a connection network topology. Also, a resource reallocation based load adjustment may be applied only to a group including database server instances within the same node, and partition reallocation based load adjustment is used in other groups, and priority of groups may be in order of a group within a node, a group within a rack, and a group between racks.

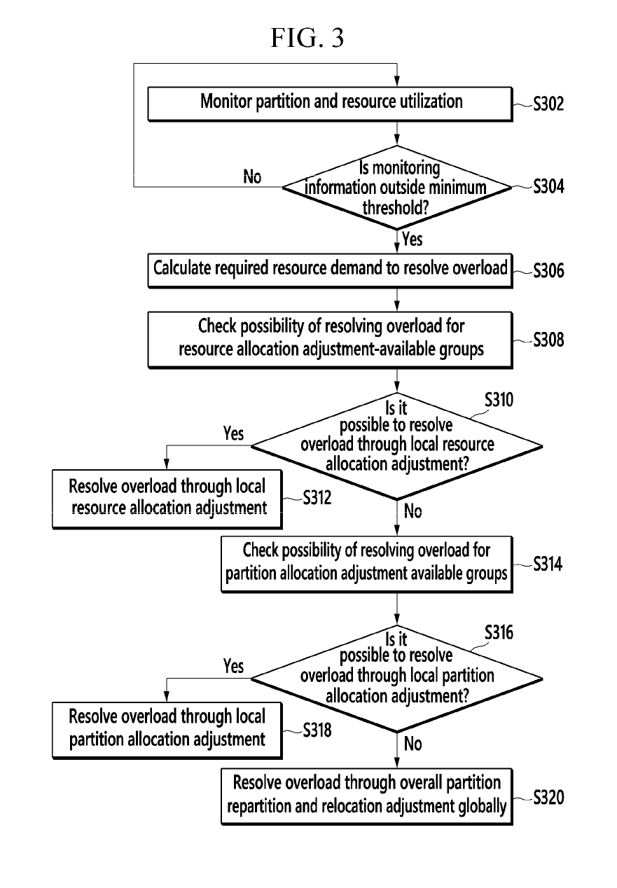

FIG. 3 is a flow chart illustrating a method for balancing loads by adjusting resource allocation and partition allocation in a distributed in-memory database system having a shared-nothing architecture according to an exemplary embodiment of the present invention.

Referring to FIG. 3, the distributed in-memory database system having a shared-nothing architecture (hereinafter, referred to as a “database system”) collects information by monitoring a partition and resource utilization status periodically or upon request (S302). For example, the database system may monitor access frequency of each partition, a access pattern of partitions (for example, information regarding partitions frequently simultaneously accessed), a cache hit/miss rate, usage of CPU/DRAM, and the like.

The database system determines whether the collected monitoring information is outside a minimum threshold for a database service (S304), and only when the collected monitoring information is outside the minimum threshold, the database system readjusts resource allocation and partition allocation. For example, a relative high usage of CPU and cache miss rate indicates an overload, and thus, the minimum threshold may be set from experience point information regarding such information.

The database system calculates a resource demand required for the overloaded database server instance outside the minimum threshold to resolve an overload (S306). The database system also calculates a resource demand of each partition in order to determine a partition candidate to be transferred, as well as a total resource demand of the overloaded database server instance. For example, the resource demand of the overloaded database server instance may be calculated on the basis of average resource usage of database server instances and resource usage of the overloaded database server instance. The resource demand of each partition may be calculated using overall CPU usage used by the overloaded database server instance, a generated memory miss rate and a size of each partition, an access frequency ratio of each partition, and the like.

In order to adjust a load, the database system determines whether it is possible to resolve overload through local resource allocation adjustment, at a first stage (S308).

When it is possible to resolve an overload through local resource allocation adjustment (S310), the overload is resolved through resource allocation adjustment (S312).

However, if it is not possible to resolve an overload through local resource allocation adjustment, the database system determines whether it is possible to resolve the overload through local partition allocation adjustment locally, at a second stage (S314).

When it is possible to resolve the overload through local partition allocation adjustment (S316), the database system resolves the overload through the local partition allocation adjustment (S318).

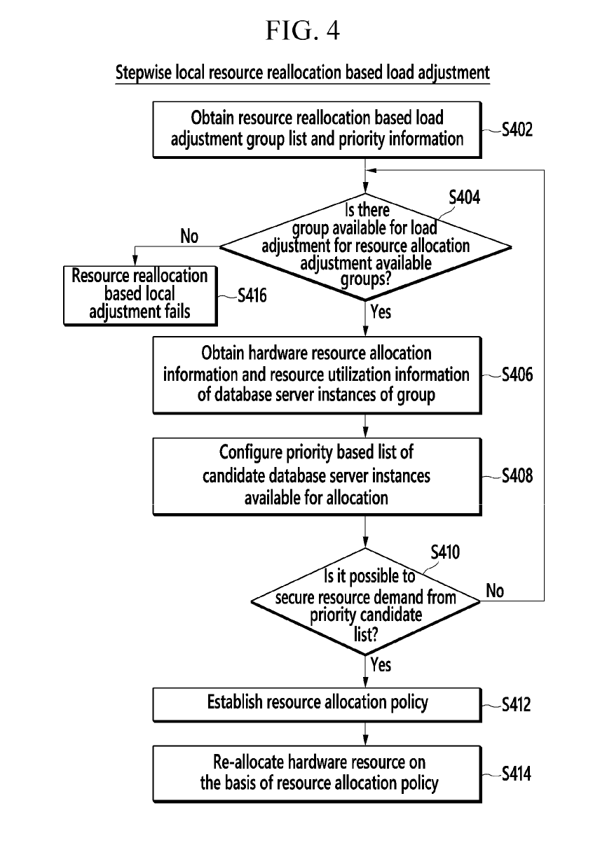

When it is not possible to resolve the overload through the local partition allocation adjustment, the database system resolves the overload through overall partition repartition and relocation adjustment globally (S320). FIG. 4 is a flow chart illustrating a method for adjusting a local load by stages on the basis of resource allocation adjustment illustrated in FIG. 3.

Referring to FIG. 4, the database system obtains information regarding a resource allocation adjustment available group list and a load adjustment priority of each group (S402).

The database system determines whether there is a group available for resource reallocation based load adjustment, starting from a group with high priority, among resource allocation adjustment available groups (S404).

In order to determine whether resource reallocation based load adjustment is possible, the database system obtains hardware resource allocation information and resource allocation information of database server instances within a corresponding group (S406), and determines whether there is much hardware resource which can be allocated to the overloaded database server instance, and configures a priority list of candidate database server instances available for allocation in consideration of a utilization rate of resource, remote memory access cost, and the like (S408).

The database system determines whether it is possible to secure a resource required for the overloaded database server instance to resolve the overload from candidate database server instances on the priority candidate list (S410).

When it is possible to secure a resource demand from the candidate database server instances on the priority candidate list, the database system establishes a most appropriate resource allocation policy (S412) and reallocates hardware resource on the basis of the resource allocation policy to (S414).

However, when it is impossible to secure a resource demand from the candidate database server instances, the database system repeats steps S406 to S410 on a group in next order, among the resource allocation adjustment available groups, according to the load adjustment priority. Repeating steps S406 to S410 is performed until it is possible to secure a resource demand or examining all resource allocation adjustment available groups.

When the resource allocation policy is a sharing policy, the database system reconfigures only a hardware environment of the overloaded database server instance, and when the resource allocation policy is a possession policy, the database system reconfigures a hardware environment of both the overloaded database server instance and the database server instance to which provides hardware resource.

The reconfigured hardware environment may be applied to a thread and page allocation executed after the reconfiguration or may be applied even to an existing executed thread and previously allocated page.

Meanwhile, when it is impossible to perform load adjustment on the resource allocation adjustment (S404), the database system determines that resource reallocation based load adjustment has failed (S416).

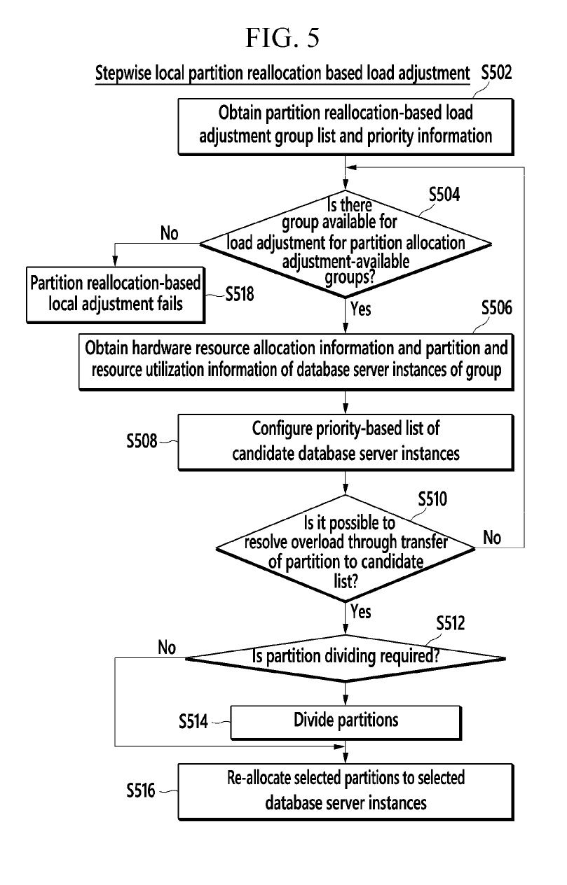

FIG. 5 is a flow chart illustrating a method for adjusting a local load by stages on the basis of partition allocation adjustment illustrated in FIG. 3.

Referring to FIG. 5, partition reallocation based load adjustment is a method of reconfiguring partitions among database server instances executed within a group. That is, according to this method, some partitions handled by the overloaded database server instance are transferred to database server instances with a less load so that the database server instances with a less load handle the partitions, or partitions to be handled are exchanged and transferred between the overloaded database server instance and the less-load database server instances.

The transferred partitions may be the entirety of specific partitions or when it is impossible to transfer the entirety of specific partitions, the partitions may be re-divided and some of the re-divided partitions may be the transferred partitions. Selection of partition candidates to be transferred and database server instances to handle the partition candidates may be determined on the basis of a computing resource amount required for each partition, relationship information between partitions, a computing resource amount which can be provided by the less-load database server instance, and the like.

In detail, the database system obtains information regarding a partition allocation adjustment available group list and inter-group load adjustment priority (S502).

The database system determines whether it is possible to perform partition reallocation based load adjustment from a group with high priority for partition allocation adjustment-available groups (S504).

In order to determine whether it is possible to perform partition reallocation based load adjustment, the database system obtains hardware resource allocation information and partition and resource utilization information of database server instances of a group (S506).

The database system checks database server instances available for participating load adjustment on the basis of the obtained information and configures a priority-based candidate list (S508). The priority-based candidate list may be configured by comprehensively determining resource utilization information, a partition utilization state, and the like.

The database system determines whether it is possible to resolve the overload through partition transfer for database server instances on a priority-based candidate list (S510). A possibility of resolving the overload through partition transfer may be checked on the basis of a resource demand required for partitions to be relocated to reduce a resource use rate of the overloaded database server instance to below a reference value and a resource amount available to be provided. The overload may be resolved through partition transfer of one database server instance according to partitions and resource utilization state of the database server instances on the priority candidate list, or two or more database server instances may participate in the partitions transfer.

If it is impossible to resolve the overload through partition transfer for the database server instances on the priority-based candidate list, the database system repeats steps S506 to S510 for a group in next order, among the partition allocation adjustment available groups, according to a load adjustment priority. Repeating steps S506 to S510 is performed until it is possible to resolve the overload through partition transfer or examining all partition allocation adjustment available groups.

The database system determines whether partitions to be relocated are required to be divided (S512). When partitions to be relocated are some of partitions allocated to the database server instances selected to participate in resolving the overload, the database system determines that partition dividing is required.

When the partitions to be relocated are required to be divided, the database system re-divides the partitions (S514) and re-allocates the re-divided partitions to the database server instances selected to participate in resolving the overload (S516).

Meanwhile, in cases where it is impossible to resolve the overload through partition relocation in the partition allocation adjustment available groups (S504), the database system determines that partition reallocation based load adjustment has failed (S518).

In cases where it is impossible to perform resource reallocation based stepwise local load adjustment illustrated in FIG. 4 and the partition reallocation based stepwise local load adjustment illustrated in FIG. 5, the database system may adjust the load by globally establishing a partition dividing and disposition plan on the basis of the existing partition dividing and disposition method.

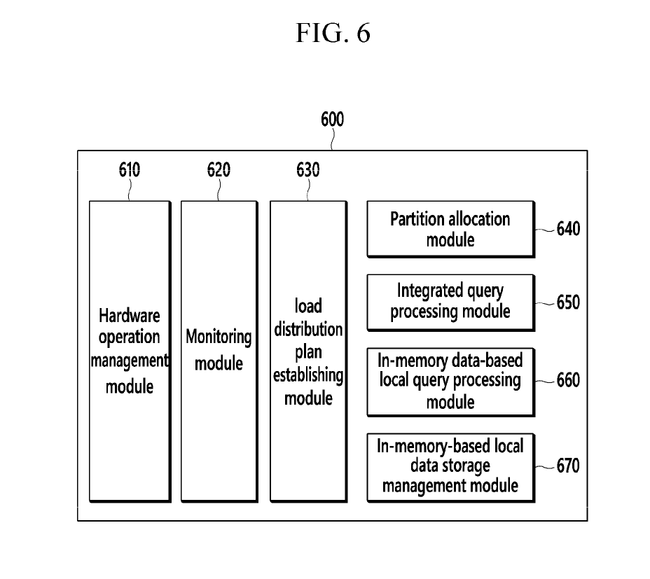

FIG. 6 is a view illustrating a module structure of a distributed in-memory database system having a shared-nothing architecture according to an exemplary embodiment of the present invention.

Referring to FIG. 6, the distributed in-memory database system having a shared-nothing architecture includes a hardware operation management module 610, a monitoring module 620, a load distribution plan establishing module 630, a partition allocation module 640, an integrated query processing module 650, an in-memory data-based local query processing module 660, and an in-memory-based local data storage management module 670.

The hardware operation management module 610 manages hardware resource allocation of a database server instance.

The monitoring module 620 monitors resource and partition utilization of a database server instance.

The load distribution plan establishing module 630 establishes a load distribution plan on the basis of monitoring information.

The partition allocation module 640 performs partition reallocation according to the load distribution plan.

The integrated query processing module 650 integratedly manages distributed database partitions and performs query processing.

The in-memory data-based local query processing module 660 performs query processing for a database partition allocated to each database server instance.

The in-memory-based local data storage management module 670 stores and manages an allocated database partition.

The database server instances illustrated in FIG. 1 each include the modules 610, 620, 630, 640, 650, 660, and 670 illustrated in FIG. 6, and a specific module is executed through role dividing and interaction among the database server instances to limit resource to be used by a database server instance, distribute a partition, store and manage a partition, perform integrated query process, and perform stepwise local load balance adjustment.

According to the exemplary embodiments of the present invention, data analytical processing performance of the existing transaction-oriented database system in the NUMA environment may be enhanced and the database system may be configured optimally according to difference in hardware of the multi-processor system with NUMA architecture.

Also, since a time and cost for adapting dynamically to a change in a workload are reduced, performance degradation due to the change in the workload may be shortened.

The exemplary embodiments of the present invention may not necessarily be implemented only through the foregoing devices and/or methods but may also be implemented through a program for realizing functions corresponding to the configurations of the embodiments of the present invention, a recording medium including the program, or the like. Such an implementation may be easily conducted by a person skilled in the art to which the present invention pertains from the foregoing description of embodiments.

The exemplary embodiments of the present invention have been described in detail, but the scope of the present invention is not limited thereto and various variants and modifications by a person skilled in the art using a basic concept of the present invention defined in claims also belong to the scope of the present invention. cm What is claimed is:

1. A distributed in-memory database system for partitioning a database and allocating the partitioned database to a plurality of distributed nodes,
wherein at least one of the plurality of nodes comprises:
a plurality of central processing unit (CPU) sockets in which a plurality of CPU cores are installed, respectively;
a plurality of memories respectively connected to the plurality of CPU to sockets and having a non-uniform memory access (NUMA) architecture in which a memory access rate of the plurality of CPU sockets is not uniform depending on a memory connection position; and
a plurality of database server instances managing allocated database partitions,
wherein each database server instance is installed in units of CPU socket groups including a single CPU socket or at least two CPU sockets.

2. The distributed in-memory database system of claim 1, wherein:
the plurality of database server instances dynamically adapt to a change in a workload to perform hardware resource allocation adjustment and partition allocation adjustment.

3. The distributed in-memory database system of claim 2, wherein:
the plurality of database server instances establish hardware resource allocation adjustment and partition allocation adjustment by stages, starting from a candidate target group incurring lower cost in consideration of cost for load adjustment and for accessing a database after load adjustment.

4. The distributed in-memory database system of claim 3, wherein:
the plurality of database server instances each adjust a load for groups available for low-cost resource reallocation based load adjustment in a first step performing local adjustment within a group by stages, starting from a group with low database access cost, and when the resource reallocation based load adjustment is impossible, the plurality of database server instances each perform local adjustment within a group by stages, starting from a group with low cost for partition transfer for groups available for partition reallocation based load adjustment.

5. The distributed in-memory database system of claim 3, wherein:
the group available for resource reallocation based load adjustment includes at least one group including database server instances driven within a node available for hardware resource sharing, and
the group available for the partition reallocation based load adjustment includes at least one group including database server instances driven in other nodes.

6. The distributed in-memory database system of claim 3, wherein:
when the overload is not resolved through the hardware resource allocation adjustment and partition allocation adjustment by stages, the plurality of database server instances re-allocate the entire partitions.

7. A method for managing a database in a distributed in-memory database system for partitioning the database and allocating the partitioned database to a plurality of distributed nodes, the method comprising:
installing and operating database server instances storing and managing a partitioned database on a at least one central processing unit (CPU) socket and a dynamic random-access memory (DRAM) directly connected to each CPU socket;
obtaining hardware allocation information and partition and resource utilization information of operated database server instances;
determining an overloaded database server instance on the basis of the hardware allocation information and the partition and resource utilization information; and
when the overloaded database server instance is present, adjusting a load of the overloaded database server instance in consideration of cost for load adjustment and for accessing a database after load adjustment.

8. The method of claim 7, wherein:
wherein at least one of the plurality of nodes comprises:
a plurality of central processing unit (CPU) sockets in which a plurality of CPU cores are installed, respectively;
a plurality of memories respectively connected to the plurality of CPU sockets and having a non-uniform memory access (NUMA) architecture in which a memory access rate of the plurality of CPU sockets is not uniform depending on a memory connection position; and
a plurality of database server instances managing an allocated database partitions.

9. The method of claim 7, wherein:
the adjusting of the load includes:
grouping database server instances in consideration of cost for adjusting the load and for accessing the database;
obtaining priority information of groups; and
performing hardware resource allocation adjustment and partition allocation adjustment by stages, starting from a group with higher priority.

10. The method of claim 9, wherein:
the grouping includes grouping database server instances driven within the same node to at least one group available for resource allocation adjustment in consideration of a memory access rate and grouping database server instances driven in other nodes to at least one group available for partition allocation adjustment in consideration of a partition transfer rate.

11. The method of claim 9, wherein:
the performing of hardware resource allocation adjustment and partition allocation adjustment includes:
a first step of performing local adjustment within a group by stages for groups available for resource reallocation based load adjustment with low cost for load adjustment; and
a second step of performing local adjustment within a group by stages for groups available for partition reallocation based load adjustment, when the resource reallocation based load adjustment is impossible.

12. The method of claim 11, wherein:
the first step includes:
obtaining the resource reallocation based load adjustment available group list and inter-group priority information;
obtaining hardware resource allocation information and resource utilization information of database server instances within a group, for each group in accordance with priority;
when available hardware resource is present on the basis of the hardware resource allocation information and resource utilization information, configuring priority of candidate database server instances to share a load in consideration of utilization of resource and cost for accessing a remote memory;
selecting at least one candidate database server instance to which hardware resource is to be provided on the basis of priority of the candidate database server instances;
establishing a resource allocation policy appropriate for the at least one selected candidate database server instance and an overloaded database server instance; and
re-allocating hardware resource to the at least one candidate database server instance and the overloaded database server instance on the basis of the resource allocation policy.

13. The method of claim 11, wherein:
the second step includes:
obtaining the partition reallocation based load adjustment available group list and inter-group priority information;
obtaining hardware resource allocation information and partition and resource utilization information of database server instances within a group, for each group in accordance with priority;
configuring priority of candidate database server instances to share a load on the basis of the hardware resource allocation information and the partition and resource utilization information;
selecting transfer partition candidates and database server instances to participate in transfer on the basis of resource utilization information and partition utilization information of each partition of the candidate database server instances and the overloaded database server instance; and
re-allocating the transfer partition candidates to the database server instances to participating in the transfer.

14. The method of claim 13, wherein:
the second step further includes: when the previous partition candidate is required to be partitioned, partitioning the corresponding partition.

15. The method of claim 9, wherein:
the adjusting of a load further includes: when the overload is not resolved through the hardware resource allocation adjustment and partition allocation adjustment by stages, re-allocating the entire partitions.
